(19) United States
(12) Patent Application Publication
(10) Pub. No.: US 2003/0236722 A1
(43) Pub. Date: Dec. 25, 2003

(54) Methods and apparatus for reserving a block of hotel rooms on short notice

(76) Inventor: Fred Kamel, Massapequa, NY (US)

Correspondence Address: Thomas M. Galgano, Esq., GALGANO & BURKE, Suite 135, 300 Rabro Drive, Hauppauge, NY, 11788, US

(21) Appl. No.: 10/176,273

(22) Filed: Jun. 19, 2002

(51) Int. Cl. G06F 17/60

(52) U.S. Cl. 705/34; 705/6

(57) ABSTRACT

A reservations processing center is coupled by communication links to hotels in the vicinity of one or more airports and coupled by communication links to airline offices in the vicinity of the same airport(s). The methods of the invention include maintaining a database (at the processing center) in which each hotel indicates the rates it has contracted with each airline, the number of currently available rooms, and today's rate (if lower than the contracted rate). If the number of rooms requested is less than or equal to twenty, the processing center compiles a list of hotels having at least the requested number of rooms available and forwards the list to the airline agent. If the number of rooms requested is greater than twenty, the reservation request is copied to participating hotels as a request for a bid. The request for bid instructs the hotels to submit their bids to a designated airline agent. The bids designate a hotel agent to contact when accepting the bid. When the airline agent receives the bids, the most appropriate bid is accepted by transmitting a bid acceptance directly to the hotel.

### BACKGROUND OF THE INVENTION

1. Field of the Invention

The invention relates to an automated hotel reservation system. More particularly, the invention relates to methods and apparatus for reserving a block of hotel rooms on short notice such as in the case of an airline booking a block of rooms for distressed passengers.

2. State of the Art

Various methods and apparatus for automating the process of hotel room reservation are known in the art. U.S. Pat. No. 3,656,113 to Lince, issued Apr. 11, 1972, discloses a “Control System for Room Reservation”. The system includes a “continuous display” of all categories of rooms available for a predetermined number of days, months, or other period of time. The system also includes means for rapidly validating reservations, recording cancellations, and updating the display. The system also records and maintains statistical data regarding arrival times, walk-ins, peak periods, etc.

A similar system is disclosed in U.S. Pat. No. 3,742,141 to Duncan et al., issued Jun. 26, 1973, which describes a “Hotel/Motel Room Status System.” The system includes an electronic circuit for each room and a central control desk with a lamp for each room. The status of the room (e.g. occupied, unmade, being cleaned, ready for occupancy, etc.) is indicated by the condition of the lamp (e.g. off, on, flashing quickly, flashing slowly, etc.) The patent suggests that the room circuits could be connected to computers or advance reservation systems, but does not describe how.

More recently, U.S. Pat. No. 5,404,291 to Kerr et al., issued Apr. 4, 1995, describes an “Inventory Control Process for Reservation Systems.” The reservations system is for hotel chains and utilizes matrix arrays defining maximum rooms for sale, protected inventory, and matrices derived from these two, all by room-type/rate-category combinations. The system provides for generalized control of inventory for sale for an arbitrary number of room-types, rate-categories, etc. The system also allows blocking or protecting inventory by rate-category, room-type, or any combination. The system allows for either a central or a distributed view of inventory, and allows inventory to be controlled by the property and sold at any location without over-selling.

A related but somewhat different system is disclosed in U.S. Pat. No. 5,832,452 to Schneider et al., issued Nov. 3, 1998, entitled “Hotel Database Inquiry System”. This patent describes a method of using a computer to select hotels described in a database. A special user interface permits entry of criteria in one or more categories that describe the hotel. The computer searches the database and displays a list of hotels that satisfy the criteria. The computer then permits the user to identify any hotel on the list and, in response, displays detailed information about that hotel. The system is essentially a searchable electronic directory of hotels and not a reservation system. There is no provision for indicating room availability. After a user has chosen a hotel, the system instructs to “contact your travel counselor for reservations”.

Most recently, U.S. Pat. No. 5,864,818 to Feldman, issued Jan. 26, 1999, discloses an “Automated Hotel Reservation Processing Method and System.” The system receives hotel reservations from a travel agent or other authorized user and enters information relating to the traveler and the reservation into a hotel reservation terminal. The reservation information is transferred to a transaction processor via a communications link, where the processor automatically generates transaction documents related to the traveler, the travel agent and the hotel accommodations. These transaction documents are then sequentially transmitted by the processor using a facsimile to various parties having an interest in the reservation transaction. A confirmation document is sent to the hotel for which the accommodations have been reserved. The banking institution through which the transaction has been financed is notified to pay the hotel and others, and the travel agent is also sent a confirming transaction document.

While these systems provide some sort of automation related to hotel room reservations, they fail to fulfill a special need in the travel industry, i.e. the need of airlines to secure last-minute reservations for “distressed” passengers. Airlines routinely need to book a block of rooms for passengers when flights are delayed, canceled, or overbooked. Because of this, most airlines enter into contracts with hotels near airports serviced by the airline. The contracts usually specify a maximum rate for which the airline will be charged per room on any night throughout the year. In some cases, the contract specifies that the hotel may offer a lower rate for a specific night depending on hotel occupancy and/or other factors.

Presently, there is no automated system for booking a block of rooms on short notice as is required by airlines. The present practice requires that an airline agent, or third party, contact some or all of the local contracting hotels to determine room availability and whether a lower than contracted rate is available.

### SUMMARY OF THE INVENTION

It is therefore an object of the invention to provide methods and apparatus for reserving a block of hotel rooms on short notice.

It is also an object of the invention to provide methods and apparatus for reserving a block of hotel rooms on short notice which satisfy the needs of airlines when booking rooms for distressed passengers.

It is another object of the invention to provide methods and apparatus for reserving a block of hotel rooms on short notice which provides the most efficient and cost effective selection of hotel rooms for airlines.

It is still another object of the invention to provide methods and apparatus for reserving a block of hotel rooms on short notice which provides equal opportunities for hotels to compete for business with the airlines.

In accord with these objects which will be discussed in detail below, the apparatus of the present invention includes a processing center which is coupled by communication links to hotels in the vicinity of one or more airports and coupled by communication links to airline offices in the vicinity of the same airport(s). According to one embodiment, the processing center is fully automated and the communication links are data links to data terminals at the respective hotels and airline offices. According to another embodiment, the processing center is semi-automatic, staffed with at least one agent, and is coupled to the respective airline offices and hotels by one or more of voice, fax, and email links. The invention also contemplates a hybrid processing center which provides fully automated service to some airline offices and/or hotels and semi-automated service to others.

The methods of the invention include maintaining a database (at the processing center) in which each hotel indicates the rates it has contracted with each airline, the number of currently available rooms, and today's rate (if lower than the contracted rate). A reservation request is initiated by an airline agent communicating the request to the processing center. According to one aspect of the invention, reservation requests are categorized based on the number of rooms requested. For example, if the number of rooms requested is less than or equal to X, the reservation request is handled in a first manner. If the number of rooms requested is greater than X, the reservation request is opened to bidding by the hotels. According to the presently preferred embodiment, if the number of rooms requested is less than or equal to twenty, the processing center compiles a list of hotels having at least the requested number of rooms available and forwards the list to the airline agent. The list preferably includes: the hotel name, the contracted rate, number of rooms available, today's rate, and the name of the agent presently on duty at the hotel. The airline agent uses this list to make reservations directly with the hotel or through the processing center. According to the presently preferred embodiment, if the number of rooms requested is greater than twenty, the reservation request is copied to participating hotels as a request for a bid. The request for bid instructs the hotels to submit their bids to a designated airline agent. The bids designate a hotel agent to contact when accepting the bid. When the airline agent receives the bids, the most appropriate bid is accepted by transmitting a bid acceptance directly to the hotel.

The presently preferred reservation request for blocks in excess of X number of rooms includes estimated arrival and departure time of the passengers, what meals, if any, will be paid for by the airline, and any other miscellaneous information the airline chooses to submit.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic diagram of a first embodiment of an apparatus according to the invention;

FIG. 2 is a schematic diagram of a second embodiment of an apparatus according to the invention;

FIG. 3 is a schematic diagram of an exemplary data terminal entry screen for requesting a reservation;

FIG. 4 is an example of a report from the processing center to an airline in response to a reservation request for twenty or fewer rooms;

FIG. 5 is an example of a request for bid copied to participating hotels when a block of more than twenty rooms is requested;

FIG. 6 is an example of a bid sent from a participating hotel to an airline agent;

FIG. 7 is an example of a bid acceptance sent from an airline agent to a bidding hotel;

FIG. 8 is a simplified flow chart of the methods of the invention for reserving rooms; and

FIG. 9 is a simplified flow chart of the methods of the invention for billing.

### DETAILED DESCRIPTION OF THE PREFERRED EMBODIMENTS

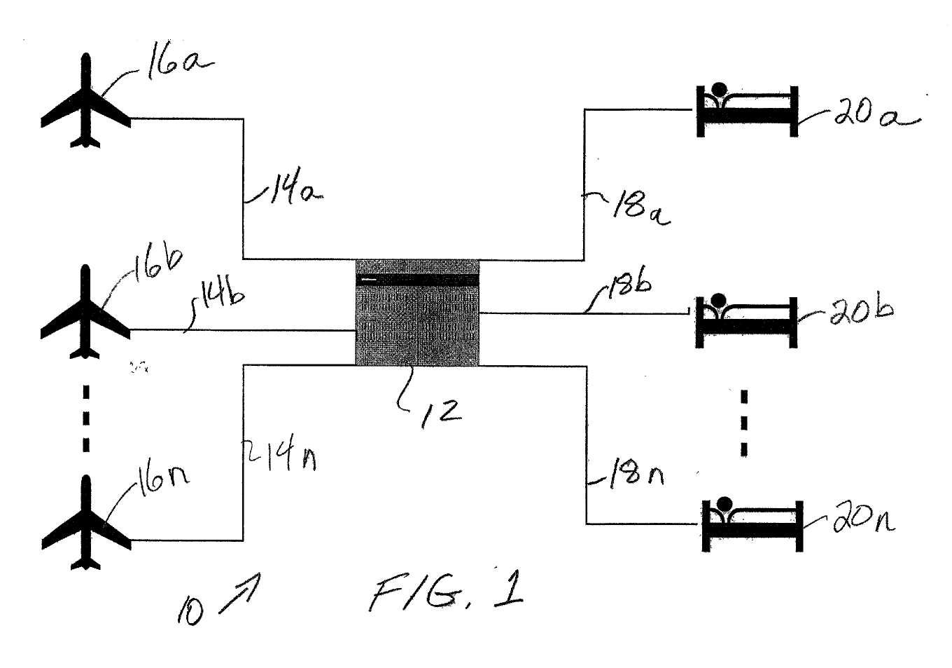

Referring now to FIG. 1, an automated system 10 according to the invention includes a processing center 12 which is coupled by communication links 14a, 14b, . . . , 14n to airline offices 16a, 16b, . . . , 16n in the vicinity of one or more airports and coupled by communication links 18a, 18b, . . . , 18n to hotels 20a, 20b, . . . , 20n in the vicinity of the same airport(s). As illustrated in FIG. 1, the processing center 12 is fully automated and the communication links 14a, 14b, . . . , 14n and 18a, 18b, . . . , 18n are data links to data terminals at the respective airline offices 16a, 16b, . . . , 16n and hotels 20a, 20b, . . . 20n.

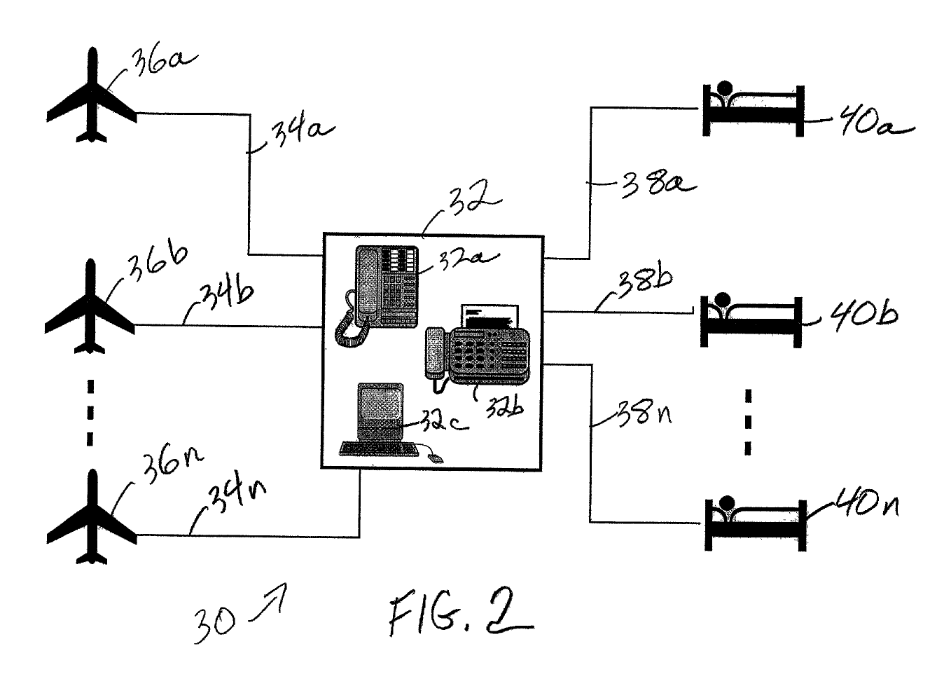

Turning now to FIG. 2, according to another embodiment, a semi-automated system 30 according to the invention includes a processing center 32 which is coupled by communication links 34a, 34b, . . . , 34n to airline offices 36a, 36b, . . . , 36n in the vicinity of one or more airports and coupled by communication links 38a, 38b, . . . , 38n to hotels 40a, 40b, . . . , 40n in the vicinity of the same airport(s). As illustrated in FIG. 2, the processing center 32 is semi-automated and includes a telephone 32a, a fax machine 32b, and a computer 32c. Consequently, the communication links 34a, 34b, . . . , 34n and 38a, 38b, . . . , 38n are voice, fax, and data links to phones, fax machines, and data terminals at the respective airline offices 36a, 36b, . . . , 36n and hotels 40a, 40b, . . . , 40n.

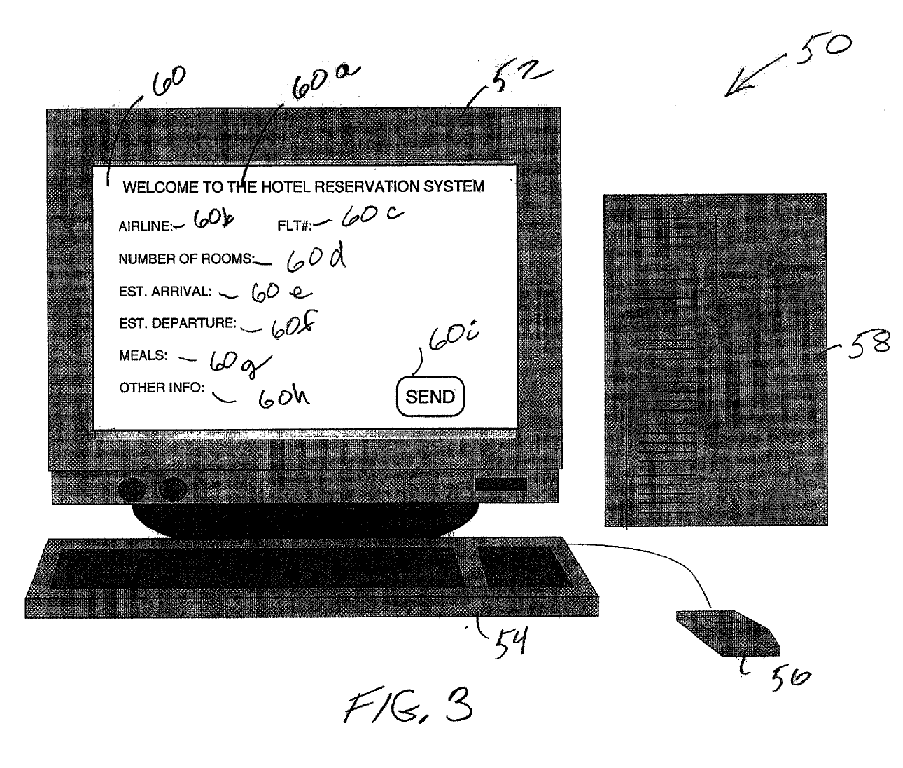

FIG. 3 illustrates an exemplary data terminal 50 according to the invention. The data terminal 50 includes a monitor 52, a keyboard 54, a mouse 56 and a cpu 58. A data entry screen 60 according to the invention includes a welcome message 60a, data entry fields 60b-60h, and a send button 60i. Exemplary data fields include airline identifier 60b, flight number 60c, number of rooms requested 60d, estimated arrival time of the passengers at the hotel 60e, estimated departure time of the passengers from the hotel 60f, an indication of which meals will be paid for by the airline 60g, and a text entry field 60h for other information. According to the invention, the airline identifier may be automatically entered according to preferences set up when the terminal 50 is installed at the airport office or via the airline's intranet. Other information such as the time and date may be automatically appended to the message when the send button 60i is clicked. The name of the airline agent to which answering messages should be sent and an indication of how the agent should be contacted (e.g. phone, fax, email) may also be included.

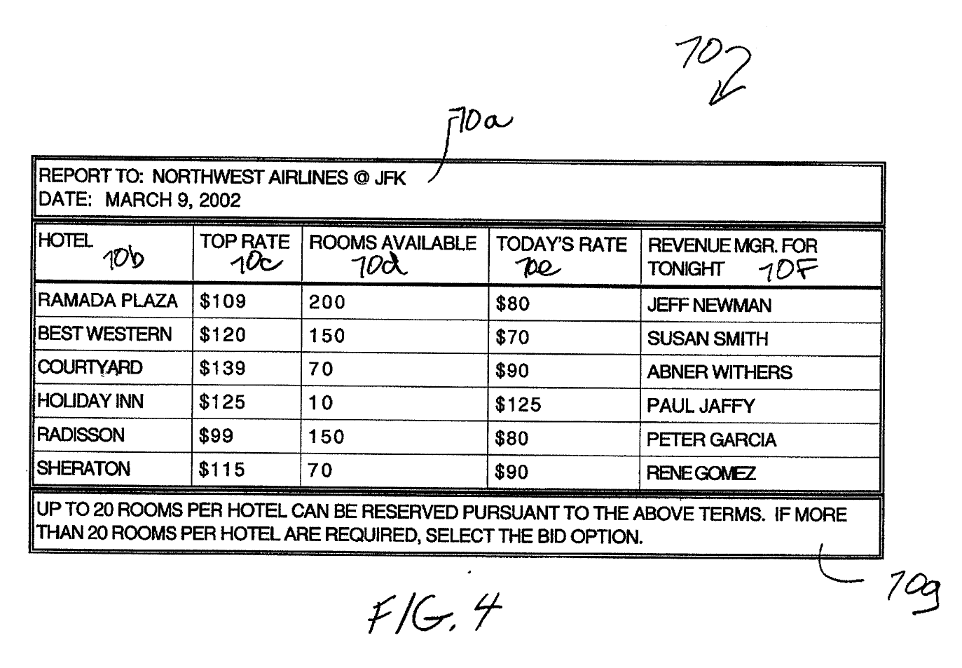

In response to a request for reservations, the central processing center may act in two ways depending on the number of rooms requested. If the number of rooms is below a threshold value (e.g. twenty) the central processing center will send a report to the airline agent by phone, fax, or email, An exemplary report 70 is shown in FIG. 4. The report 70 includes a header 70a, collimated data 70b-70f, and a footer 70g. According to the presently preferred embodiment, the collimated data preferably includes the name of the hotel 70b, the top rate 70c, the number of rooms available 70d, today's rate 70e, and the name of the hotel agent on duty 70f. The header 70a may include the date and addressing information. The footer 70g may include instructions or explanatory information. As mentioned above, the top rate 70c is the rate at which the hotel has contracted with the airline and today's rate 70e is a rate calculated by the hotel on a daily basis considering the number of rooms available and the season.

According to the invention, the airline agent may use the information in the report 70 to call (phone, fax, or email) a hotel selected from the list and make the reservation.

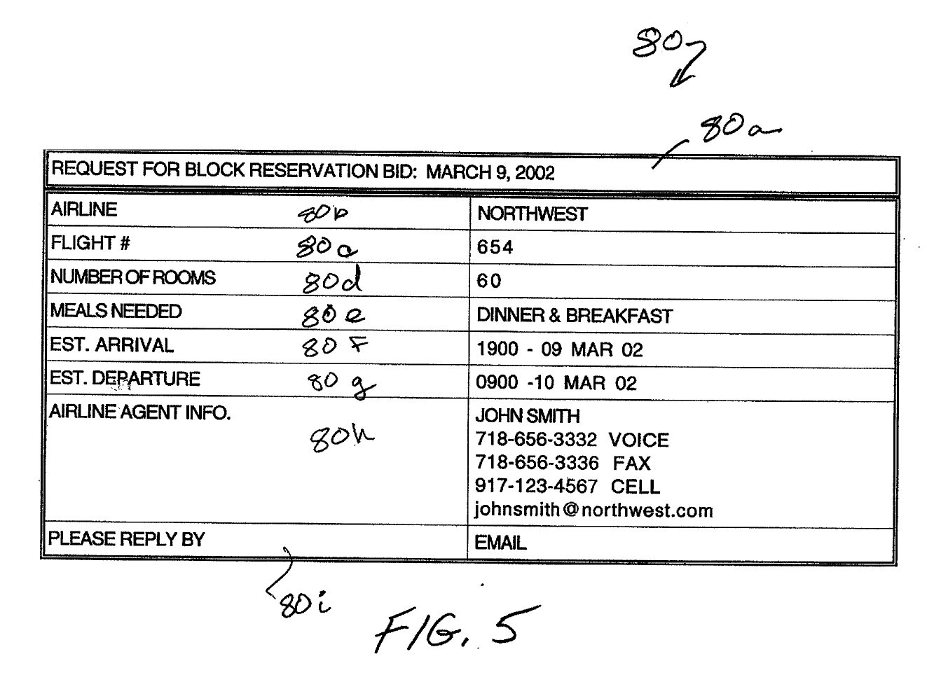

As mentioned above, according to the invention, if the number of rooms requested by the airline is greater than a threshold number, the request will be sent to all participating hotels for bidding. FIG. 5 illustrates a sample request for block reservation bid 80. This request may be generated automatically at the data terminal in the airline office or may be generated at the central processing center in response to a phone call, fax, or email. The sample message 80 includes a header 80a and rows of data 80b-80i. The data preferably includes the name of the airline 80b, the flight number 80c, the number of rooms requested 80d, an indication of the meals to be included 80e, estimated arrival time 80f, estimated departure time 80g, contact information for the airline agent 80h, and an indication of the preferred contact method 80i.

The request 80 is copied to all of the participating hotels and hotels wishing to bid reply directly to the airline agent.

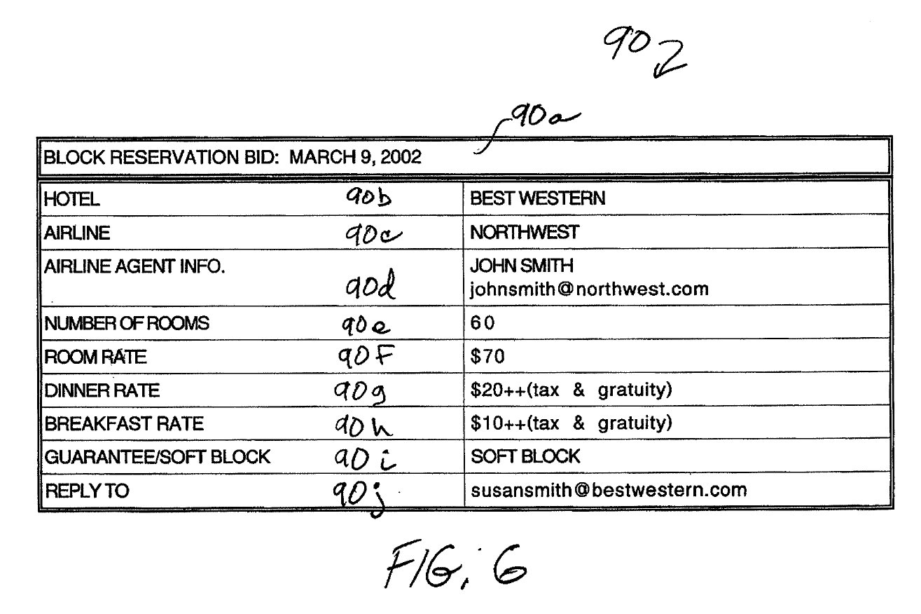

FIG. 6 illustrates a sample bid 90 sent by fax or email. The bid 90 includes a header 90a and rows of data 90b-9j. The data preferably includes the name of the hotel 90b, the name of the airline 90c, airline agent contact information 90d, the number of rooms 90e, the room rate 90f, the cost of meals requested 90g, 90h, the type of reservation offered 90i, and the hotel contact information 90j. The type of reservation 90i is either a guaranteed reservation or a “soft block”. A guaranteed reservation will require the airline to pay for the rooms whether or not they are used and will guarantee that the rooms will be available for the requested time. A guaranteed reservation will usually be required only if rooms are in short supply, e.g. due to the season or due to weather canceled flights.

The airline agent who requested the bid will typically receive several bids in reply and will select one for booking the reservation.

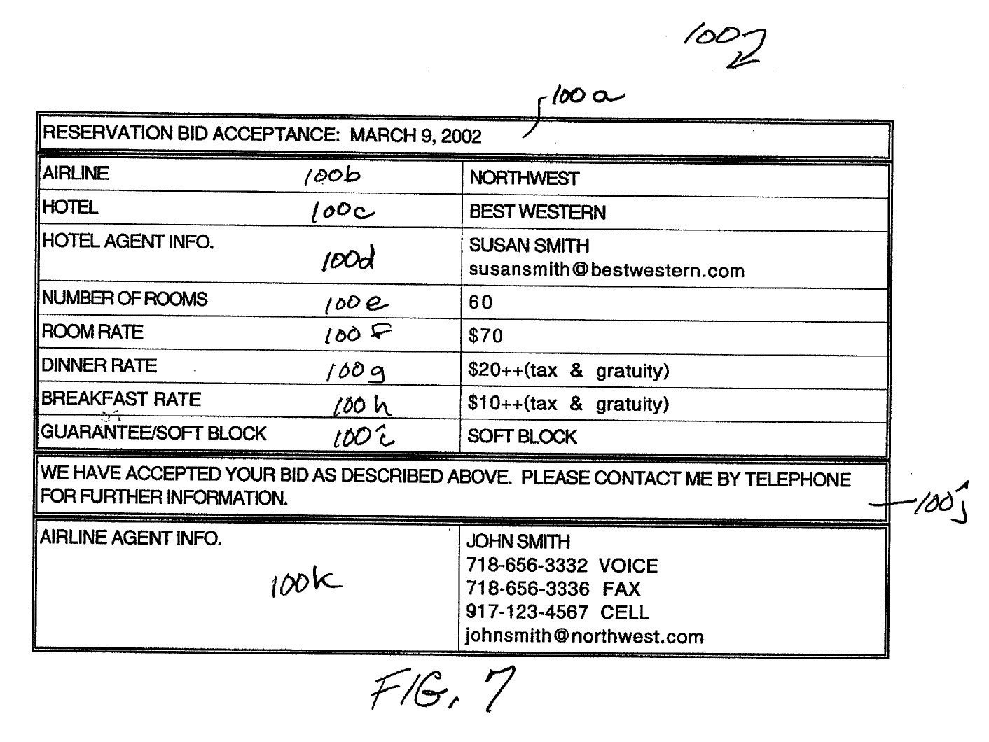

FIG. 7 illustrates a sample reservation bid acceptance 100 for fax or email transmittal. The bid acceptance 100 includes a header 100a, several rows of data 100b-100i, a message field 100j, and airline agent contact information 100k. The header 100a includes the date and an indication of the communication is a reservation bid acceptance. The rows of data preferably include the name of the airline 100b, the name of the hotel 100c, hotel agent contact information 100d, the number of rooms 100e, the room rate 100f, the cost of meals 100g, 100h, and the type of reservation 100i.

As mentioned above, the methods of the invention include maintaining a database (at the processing center) in which each hotel indicates the rates it has contracted with each airline, the number of currently available rooms, and today's rate (if lower than the contracted rate).

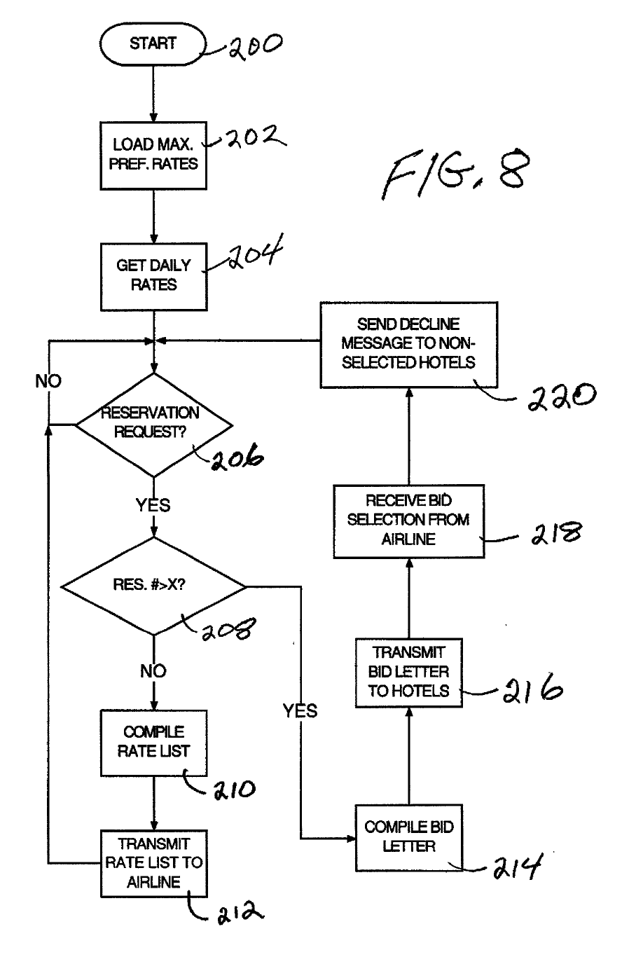

Turning now to FIG. 8, the methods of the invention with regard to reserving rooms are illustrated in a flow chart of a computer program running at the central processing center 12 in FIG. 1 or 32 in FIG. 2. Starting at 200, the program loads the maximum preferred rates at 202 and loads the daily rates and rooms available at 204. With this information, the system waits at 206 for a reservation request. When a reservation request is received, it is determined at 208 whether the number of rooms requested is greater than the threshold number X (presently preferred to be twenty). If the number of rooms requested exceeds the threshold as determined at 208, a request for bid letter (of the type shown in FIG. 5) is compiled at 214 and is transmitted (typically by fax or email) to the hotels at 216. In the rare instance that a hotel is not equipped with fax or email capabilities, the information assembled at 214 may be communicated orally via telephone at 216.

According to the invention, once the request for bid letter is sent at 216, the airline may make the reservation directly with the hotel or via the processing center. In either case, the processing center must be notified of the selected hotel at 218 so that it cab send decline messages at 220 to the bidding hotels which were not selected. It will be appreciated from the discussion above of FIGS. 6 and 7 that upon receipt of the request for bid letter, the hotels will formulate bids and transmit the bids to the airline involved. The airline will then accept the bid it chooses. The bidding process may be open or closed based on the vote of the participating hotels in each city.

Returning now to FIG. 8, if the reservation request detected at 206 is for less than the threshold X number of rooms as determined at 208, a rate list of the type shown in FIG. 4 is compiled at 210 based on the data loaded at 202 and 204. The rate list is then transmitted (typically by fax or email) to the airline agent at 212. In the rare instance that the airline office is not equipped with fax or email capabilities, the information assembled at 210 may be communicated orally via telephone at 212.

According to the invention, once the rate list is sent at 212, the airline may make a booking directly with the hotel or through the processing center. It will be appreciated from the discussion above of FIG. 4 that upon receipt of the rate list, the airline office will choose one or more hotels and make the reservations directly with the hotel agent(s).

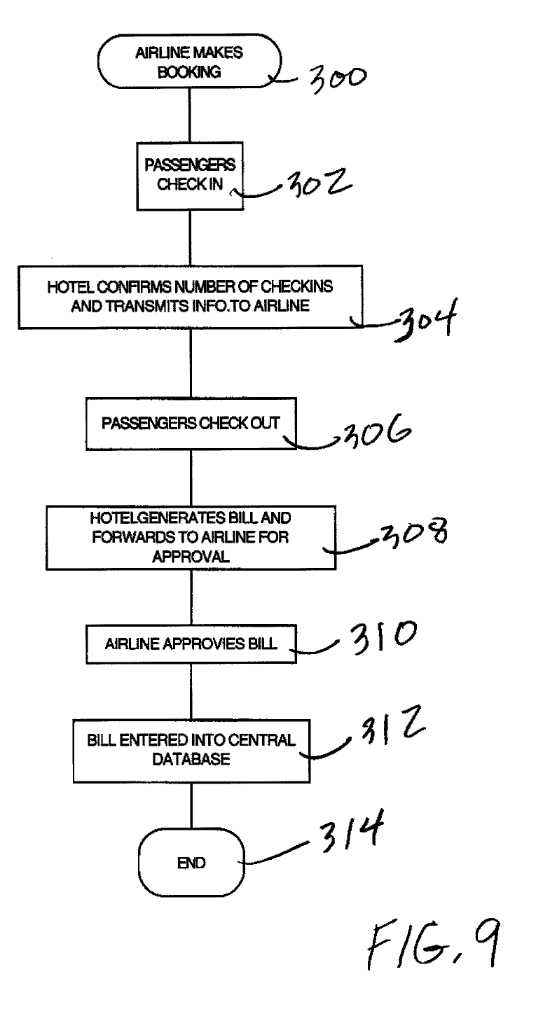

Once a booking is made, the processing center participates in billing as illustrated in FIG. 9.

Referring now to FIG. 9, after an airline makes a booking at 300, passengers check in to the hotel at 302. When it becomes apparent that all passengers have checked it the hotel confirms the number of passengers checked in and transmits that information to the airline at 304.

When the passengers check out at 306, the hotel prepares a draft bill and forwards it to the airline at 308. When the airline approves the bill at 310, it is entered into the central database at 312 so that it may be viewed by the airline head office and so that it may be thereby paid.

According to the presently preferred embodiment, all accounting information as far as what is billed and what will be approved are entered in the central database and the hotel is then assured that whatever they bill, they will collect.

As mentioned above, it is preferred that reporting will be available to the head office of the airline to track the expenses per city.

It is also presently preferred that all the rates for the various airlines, including but not limited to room, meals, telephone charges are input into the central database by the hotels.

It is presently preferred that all reservations, whether one room or a hundred rooms, are all entered in the database in order to keep the integrity of the accounting reports that are generated for the respective airline's head office.

It is also preferred to know that the central processing center is always involved in order to capture the data. The airline might deal directly with the hotel, however the billing information should be transmitted to the processing center for the following reasons:

a) the processing center should know each and every room booked so that commission is earned from each room; and

b) the processing center should know each and every room booked so that all accounting reports will be generated from this system.

There have been described and illustrated herein several embodiments of methods and apparatus for reserving a block of hotel rooms on short notice. While particular embodiments of the invention have been described, it is not intended that the invention be limited thereto, as it is intended that the invention be as broad in scope as the art will allow and that the specification be read likewise. Thus, while particular formats of communications have been disclosed, it will be appreciated that other formats could be utilized. Also, while particular hardware and software have been shown for effecting the methods of the invention, it will be recognized that other types of hardware and/or software could be used with similar results obtained. Moreover, while particular configurations have been disclosed in reference to daily rates and guaranteed reservations, it will be appreciated that other configurations could be used as well. For example, a hotel may opt to set a daily rate less frequently than daily and a hotel may accept a percentage of the total room rate for a reservation guarantee. Furthermore, while the central processing center has been shown to be coupled to a number of hotels and airline offices in the vicinity of one or more airports, the geographical scope of service provided by the invention is not limited. There may be a single processing center for each airport, for a group of airports, or for an entire region. Moreover, it is consistent with the methods of the invention to provide a separate processing center for each airline. For example, in a fully automated embodiment of the invention, the methods of the invention can be carried out entirely within and through a single desktop computer in the airline office. It will therefore be appreciated by those skilled in the art that yet other modifications could be made to the provided invention without deviating from its spirit and scope as so claimed.

1. A method for reserving a block of hotel rooms, said method comprising:
a) maintaining a database which includes, for each of a plurality of hotels, the number of rooms available and a room rate;
b) receiving a reservation request from a requestor for n number of rooms;
c) compiling a list from the database of hotels having at least n number of rooms available, the list including the name of the hotel, the number of rooms available, and the room rate; and
d) communicating the list to the requestor.

2. The method according to claim 1, wherein:
the room rate includes a maximum rate and a daily rate.

3. The method according to claim 2, wherein:
the list includes the lower of the maximum rate and the daily rate.

4. The method according to claim 2, wherein:
for at least some of the hotels, the maximum rate is set by contract between the requestor and the hotel.

5. The method according to claim 1, wherein:
the list includes hotel contact information.

6. A method for reserving a block of hotel rooms, said method comprising:
a) maintaining a database which includes, for each of a plurality of hotels, the number of rooms available;
b) receiving a reservation request from a requestor for n number of rooms;
c) compiling a request for bid based on the reservation request;
d) communicating the request for bid to hotels selected from the database which have at least n number of rooms available, the request for bid including the number of rooms n requested by the requestor.

7. The method according to claim 6, wherein:
the request for bid identifies the requestor and provides contact information for the requestor.

8. A method for reserving a block of hotel rooms, said method comprising:
a) maintaining a database which includes, for each of a plurality of hotels, the number of rooms available and a room rate;
b) receiving a reservation request from a requestor for n number of rooms;
c) if n is less than or equal to X,
compiling a list from the database of hotels having at least n number of rooms available, the list including the name of the hotel, the number of rooms available, and the room rate, and
communicating the list to the requestor;
d) if n is greater than X,
compiling a request for bid based on the reservation request, and
communicating the request for bid to hotels selected from the database which have at least n number of rooms available, the request for bid including the number of rooms n requested by the requestor.

9. The method according to claim 8, wherein:
the room rate includes a maximum rate and a daily rate.

10. The method according to claim 9, wherein:
the list includes the lower of the maximum rate and the daily rate.

11. The method according to claim 9, wherein:
for at least some of the hotels, the maximum rate is set by contract between the requestor and the hotel.

12. The method according to claim 8, wherein:
the list includes hotel contact information.

13. The method according to claim 8, wherein:
the request for bid identifies the requestor and provides contact information for the requestor.

14. An apparatus for reserving a block of hotel rooms, said apparatus comprising:
a) a database which includes, for each of a plurality of hotels, the number of rooms available and a room rate;
b) means for receiving a reservation request from a requestor for n number of rooms;
c) means for compiling a list from the database of hotels having at least n number of rooms available, the list including the name of the hotel, the number of rooms available, and the room rate; and
d) means for communicating the list to the requestor.

15. The apparatus according to claim 14, wherein:
the room rate includes a maximum rate and a daily rate.

16. The apparatus according to claim 15, wherein:
the list includes the lower of the maximum rate and the daily rate.

17. The apparatus according to claim 15, wherein:
for at least some of the hotels, the maximum rate is set by contract between the requestor and the hotel.

18. The apparatus according to claim 14, wherein:
the list includes hotel contact information.

19. An apparatus for reserving a block of hotel rooms, said apparatus comprising:
a) a database which includes, for each of a plurality of hotels, the number of rooms available;
b) means for receiving a reservation request from a requestor for n number of rooms;
c) means for compiling a request for bid based on the reservation request;
d) means for communicating the request for bid to hotels selected from the database which have at least n number of rooms available, the request for bid including the number of rooms n requested by the requestor.

20. The apparatus according to claim 19, wherein:
the request for bid identifies the requestor and provides contact information for the requestor.

21. An apparatus for reserving a block of hotel rooms, said method comprising:
a) a database which includes, for each of a plurality of hotels, the number of rooms available and a room rate;
b) means for receiving a reservation request from a requestor for n number of rooms;
c) means for compiling a list from the database of hotels having at least n number of rooms available if n is less than or equal to X, the list including the name of the hotel, the number of rooms available, and the room rate;
d) means for communicating the list to the requestor if n is less than or equal to X;
e) means for compiling a request for bid based on the reservation request if n is greater than X; and
f) means for communicating the request for bid to hotels selected from the database which have at least n number of rooms available if n is greater than X, the request for bid including the number of rooms n requested by the requestor.

22. The apparatus according to claim 21, wherein:
the room rate includes a maximum rate and a daily rate.

23. The apparatus according to claim 22, wherein:
the list includes the lower of the maximum rate and the daily rate.

24. The apparatus according to claim 22, wherein:
for at least some of the hotels, the maximum rate is set by contract between the requestor and the hotel.

25. The apparatus according to claim 21, wherein:
the list includes hotel contact information.

26. The apparatus according to claim 21, wherein:
the request for bid identifies the requestor and provides contact information for the requestor.

27. A method for billing the reservation of a block of hotel rooms, comprising:
receiving a reservation for a block of rooms from a requestor;
counting the number of guests who check in under the reservation;
communicating the number of checked in guests to the requestor; and
preparing a bill when all of the checked in guests check out;
forwarding the bill to the requestor for approval.

28. The method according to claim 27, further comprising:
receiving bill approval from the requestor; and
forwarding the approval bill to a processing center.
